(19) United States
(12) Patent Application Publication
(10) Pub. No.: US 2012/0116958 A1
(43) Pub. Date: May 10, 2012

(54) SYSTEMS, DEVICES AND METHODS FOR ELECTRONICALLY GENERATING, EXECUTING AND TRACKING CONTRIBUTION TRANSACTIONS

(76) Inventor: Cameron W. Soholt, Redondo Beach, CA (US)

(21) Appl. No.: 13/291,794

(22) Filed: Nov. 8, 2011

Related U.S. Application Data
(60) Provisional application No. 61/411,595, filed on Nov. 9, 2010.

(51) Int. Cl. G06Q 40/00

(52) U.S. Cl. 705/39

(57) ABSTRACT

A contribution aggregation system enables a user to purchase or otherwise acquire a block of one or more contribution units from which to contribute desired amounts to selected recipients. This may be performed, for example, by the user logging on to a Web site or other system interface provided by the contribution aggregation computer system and then selecting individual recipients to receive selected donation or contribution amounts. These amounts from various different contributors are then aggregated and totaled to enable a single contribution transaction to be made to the recipient including the amounts contributed to the recipient form the various contributors. The current balance of the contributor's block of one or more contribution units is tracked and the contributor may also input or select comments and/or conditions associated with their individual contributions to individual recipients to be sent to the recipient or otherwise published.

### BACKGROUND

1. Field

This disclosure generally relates to electronic contribution transactions, and particularly to electronically tracking contributions.

2. Description of the Related Art

With the growing number of charitable organizations or other non-profit organizations from which contributors or donors may choose to make contributions, there are often multiple individual contributors that would like to make various contributions or donations in smaller amounts to various different organizations. However, the transaction costs for making such smaller individual donations is generally high compared to the individual contribution amount. Hence, new approaches to providing, generating, executing and tracking contributions are desirable.

### BRIEF SUMMARY

A method of operating an electronic contribution aggregation and allocation system including at least one processor and at least one non-transitory computer readable medium coupled to the at least one processor may be summarized as including receiving a plurality of electronic requests from a plurality of contributors by the at least one processor, each request being for a block of one or more contribution units; allocating a respective block of one or more contribution units to each of the plurality of contributors, by the at least one processor, in response to the receiving of the plurality of requests; receiving a plurality of electronic indications from one or more of the plurality of contributors by the at least one processor, wherein each indication is indicative of a respective contribution amount from a respective contributor to a respective recipient of a plurality of recipients; for each of the one or more of the plurality of contributors, adjusting an amount of remaining contribution units in the respective block of one or more contribution units based on the respective contribution amount, by the at least one processor; and for each respective recipient of the plurality of recipients, aggregating the respective contribution amounts for the respective recipient into a respective aggregated contribution for the respective recipient, by the at least one processor.

The computer-implemented method may further include for each respective recipient of the plurality of recipients, electronically disbursing in one transaction to the respective recipient the respective aggregated contribution for the respective recipient by the at least one processor.

The computer-implemented method may further include for at least one of the one or more of the plurality of contributors: receiving data regarding the respective contribution amount, by the at least one processor; associating the received data regarding the respective contribution amount with the respective recipient, by the at least one processor; storing the received data regarding the respective contribution amount; and storing the association of the received data regarding the respective contribution amount, by the at least one processor.

The received data regarding the respective contribution amount may be data regarding reasons or motivations that the at least one of the one or more of the plurality of contributors made the respective contribution amount.

The computer-implemented method may further include electronically publishing the data regarding the respective contribution amount by the at least one processor.

The computer-implemented method may further include electronically publishing the data regarding the respective contribution amount, by the at least one processor; and electronically publishing the respective contribution amount in relation to the data regarding the respective contribution, by the at least one processor.

The computer-implemented method, wherein the at least one of the one or more of the plurality of contributors may include multiple contributors and may further include aggregating, by the at least one processor, the received data regarding the respective contribution amount from the each of the multiple contributors based on the respective recipient; and electronically communicating, by the at least one processor, the aggregated received data for the respective recipient to the respective recipient along with the electronic disbursement to the respective recipient. The received data regarding the respective contribution amount may be data regarding a condition for disbursing the respective contribution amount, the condition being a status or action of the respective recipient.

The computer-implemented method may further include receiving, by the at least one processor, an electronic indication indicating whether the condition has been met; and electronically disbursing, by the at least one processor, the respective contribution amount if the received electronic indication indicates the condition has been met; and preventing, by the at least one processor, electronic disbursing of the respective contribution amount if the received electronic indication indicates the condition has not been met. The receiving a plurality of electronic indications may be performed before the receiving the plurality of electronic requests and the allocating the respective block of one or more contribution units.

A system may be summarized as including at least one processor; at least one processor-readable memory that stores instructions executable by the at least one processor to cause the at least one processor to: receive a plurality of electronic indications from one or more of a plurality of contributors, wherein each indication is indicative of a respective contribution amount from a respective contributor to a respective recipient of a plurality of recipients; and for each respective recipient of the plurality of recipients, aggregate the respective contribution amounts for the respective recipient into a respective aggregated contribution for the respective recipient; and for each respective recipient of the plurality of recipients, electronically disburse to the respective recipient in one transaction the respective aggregated contribution for the respective recipient.

The system wherein the instructions executable by the at least one processor may further cause the at least one processor to: for each of the one or more of the plurality of contributors: receive data regarding the respective contribution amount; associate the received data regarding the respective contribution amount with the respective contribution amount and the respective recipient; store the received data regarding the respective contribution amount; and store the association of the received data regarding the respective contribution amount.

The system wherein the data regarding the respective contribution amount may include data regarding a reason for making the respective contribution and the instructions executable by the at least one processor may further cause the at least one processor to: for each respective recipient of the plurality of recipients, generate statistical data regarding one or more reasons why contributions were made to the respective recipient based on the stored association of the received data regarding the respective contribution amount from each of the one or more of the plurality of contributors.

The system wherein the instructions executable by the at least one processor may further cause the at least one processor to: for each respective recipient of the plurality of recipients, electronically communicate to the respective recipient the generated statistical data regarding the one or more reasons why contributions were made to the respective recipient.

The system wherein the instructions executable by the at least one processor may further cause the at least one processor to: electronically publish the generated statistical data regarding the one or more reasons why contributions were made to the respective recipient.

The system wherein the instructions executable by the at least one processor may further cause the at least one processor to: generate a user interface to enable entering the respective contribution amount from the respective contributor to the respective recipient, the user interface including: a list of the a plurality of recipients; an area of the user interface associated with the list of the plurality of recipients configured to enable an indication to be entered by the respective contributor of an amount of contribution to be made to one or more of the plurality of recipients; an area of the user interface to enable the user to input information regarding one or more of: the respective contribution and the respective recipient. The information may include one or more of: a reason for making the respective contribution and comments regarding the respective recipient.

The system wherein the instructions executable by the at least one processor may further cause the at least one processor to: receive a plurality of electronic requests from the plurality of contributors, each request being for a block of one or more contribution units; and allocate a respective block of one or more contribution units to each of the plurality of contributors in response to the receiving of the plurality of requests.

A non-transitory computer-readable medium that may store instructions that when executed by at least one computer system may cause the at least one computer system to perform: receiving a plurality of electronic requests from a plurality of contributors, each request being for a block of one or more contribution units; allocating a respective block of one or more contribution units to each of the plurality of contributors in response to the receiving of the plurality of requests; and for each of one or more of the plurality of contributors, adjusting an amount of remaining contribution units in the respective block of one or more contribution units based on a total of respective contribution amounts of the contributor.

The instructions may further cause the at least one computer system to perform: for at least one of the one or more of the plurality of contributors: receiving data regarding a respective contribution amount of the at least one contributor; associating the received data regarding the respective contribution amount with a respective recipient; storing the received data regarding the respective contribution amount; and storing the association of the received data regarding the respective contribution amount. The received data regarding the respective contribution amount may be data regarding reasons or motivations that the at least one contributor made the respective contribution amount.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment, including a number of servers and a number of clients communicatively coupled to the servers by one or more networks, of which systems, devices and methods for electronically generating, executing and tracking contribution transactions may be a part, or in which they may be implemented, according to one illustrated embodiment.

FIG. 2 is a schematic diagram of an electronic commerce environment having example contributor computing systems, an example contribution aggregation computer system, and an example recipient computer system, according to one illustrated embodiment.

FIG. 3 is a diagram of an example contributor user interface, according to one illustrated embodiment.

FIG. 4 is a diagram of an example database table of the aggregation computer system, according to one illustrated embodiment.

FIG. 5 is a flow diagram showing a method of electronically aggregating respective contribution amounts, according to one illustrated embodiment.

FIG. 6 is a flow diagram showing a method of electronically disbursing aggregated contributions, according to one illustrated embodiment.

FIG. 7 is a flow diagram showing a method of electronically adjusting an amount of remaining contribution units in a respective block of one or more contribution units, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including contributor and server computing systems, as well as networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

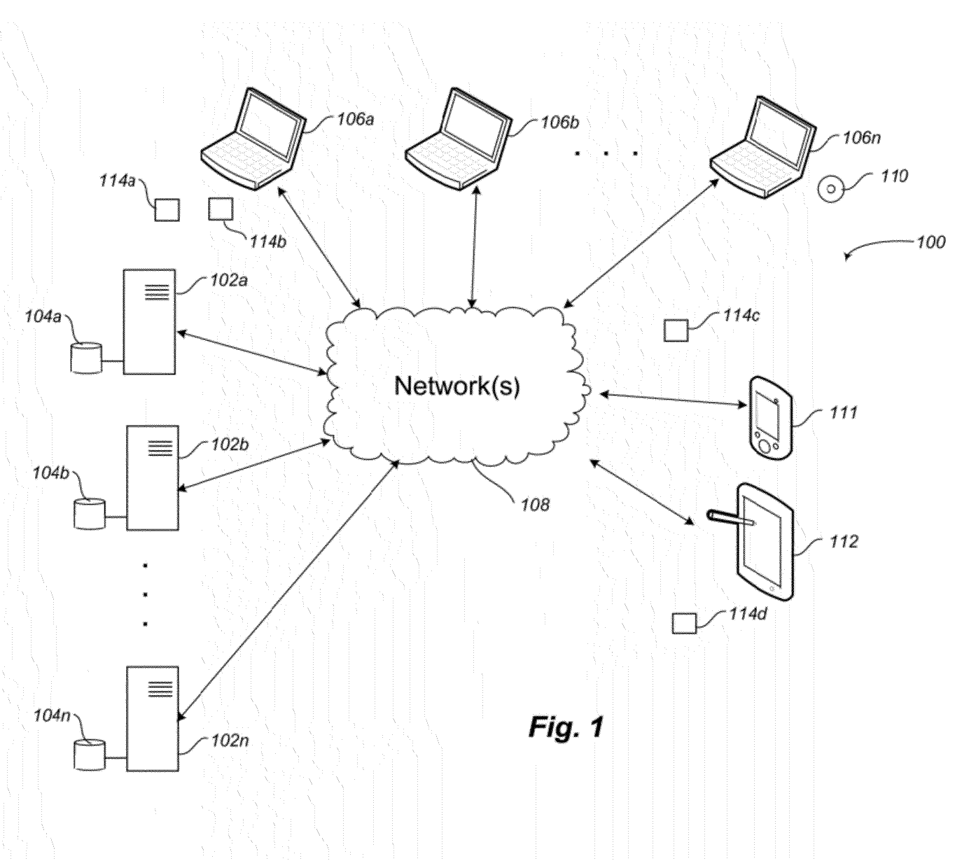

FIG. 1 shows a networked environment 100, including a number of servers and a number of clients communicatively coupled to the servers by one or more networks, of which systems, devices and methods for electronically generating, executing and tracking contribution transactions may be a part, or in which they may be implemented, according to one illustrated embodiment. “Contribution” as used herein may include one or more of: a donation amount, a gift amount a payment amount, etc., wherein the amount may be in any denomination of something of value including monetary currency, units, credits, work hours, a number of physical items, etc. A contribution may be made to any organization or individual including, but not limited to, a charitable organization, political organization, non-profit organization, governmental organization, foundation, business, political campaign, political cause, individual, etc.

The network environment 100 includes a number of server computing systems 102a-102n (collectively 102). The server computing systems 102 include processors that execute server instructions (i.e., server software) stored on computer-readable storage media to provide server functions in the network environment 100. For example, the server computing systems 102 may electronically generate, execute and/or track contribution transactions or indications of contributions, stored in one or more databases or other computer-readable storage media 104a-104n (collectively 104).

The network environment 100 includes a number of client computing systems 106a-106n (collectively 106) selectively communicatively coupled to one or more of the server computing systems 102 via one or more communications networks 108. The client computing systems 106 include one or more processors that execute one or more sets of communications instructions (e.g., browser instructions and streaming media players) stored on any of a variety of non-transitory computer-readable storage media 110 (only one illustrated in FIG. 1). The client computing systems 106 may take a variety of forms, for instance desktop, laptop or notebook personal computers, tablet computers, workstations, mini-computers, mainframe computers, or other computational devices with microprocessors or microcontrollers which are capable of networked communications. The client computing systems 106 may be communicatively coupled to the rest of the network 108 via wired, wireless or a combination of wired and wireless communications channels.

The network environment 100 includes a number of telecommunications devices 111 (only one illustrated). Such telecommunications devices 111 may, for example, take the form of Internet or Web enabled cellular phones (e.g., iPHONE®). The network environment 100 also includes a number of personal digital assistant (PDA) devices 112 (only one illustrated). Such PDA devices 112 may, for example, take the form of Internet or Web enabled PDAs or tablet computers (e.g., iPHONE®, iPAD®, TREO®, BLACKBERRY®), which may, for example, execute a set of browser instructions or program. The network environment 100 may include any number of a large variety of other devices that are capable of some type of networked communications. The telecommunications devices 110, PDA devices 112, as well as any other devices, may be communicatively coupled to the rest of the network 108 via wired, wireless or a combination of wired and wireless communications channels.

The one or more communications networks 108 may take a variety of forms. For instance, the communications networks 108 may include wired, wireless, optical, or a combination of wired, wireless and/or optical communications links. The one or more communications networks 108 may include public networks, private networks, unsecured networks, secured networks or combinations thereof. The one or more communications networks 108 may employ any one or more communications protocols, for example TCP/IP protocol, UDP protocols, IEEE 802.11 protocol, as well as other telecommunications or computer networking protocols. The one or more communications networks 108 may include what are traditionally referred to as computing networks and/or what are traditionally referred to as telecommunications networks or combinations thereof. In at least one embodiment, the one or more communications networks 108 includes the Internet, and in particular, the Worldwide Web or (referred to herein as “the Web”). Consequently, in at least one embodiment, one or more of the server computing systems 102 execute server software to serve HTML source files or Web pages 114a-114d (collectively 114), and one or more client computing systems 106, telecommunications devices 110 and/or PDAs 112 execute browser software to request and display HTML source files or Web pages 114 including streaming media content.

The network environment 100 includes an interactive system for electronically accepting, generating, executing and/or tracking contribution transactions. The interactive system for electronically accepting, generating, executing and/or tracking contribution transactions may include one or more server computing systems 102, databases 104 and one or more client systems 106, telecommunications devices 111, and/or PDA devices 112.

The one or more server computing systems 102 execute instructions stored on non-transitory computer-readable storage media that cause the server computing systems 102 to electronically accept, generate, execute and/or track contribution transactions with respect to and/or between on one or more client systems 106, telecommunications devices 111, and/or PDA devices 112, and provide communications during or in connection with such services to and between one or more client systems 106, telecommunications devices 111, and/or PDA devices 112.

Although not required, the embodiments will be described in the general context of computer-executable instructions, such as program application engines, objects, or macros stored on computer- or processor-readable storage media and executed by a computer or processor. Those skilled in the relevant art will appreciate that the illustrated embodiments as well as other embodiments can be practiced with other affiliated system configurations and/or other computing system configurations, including hand-held devices, multiprocessor systems, microprocessor-based or programmable consumer electronics, personal computers (“PCs”), network PCs, mini-computers, mainframe computers, and the like. The embodiments can be practiced in distributed computing environments where tasks or acts are performed by remote processing devices, which are linked through a communications network. In a distributed computing environment, program engines may be located in both local and remote memory storage devices.

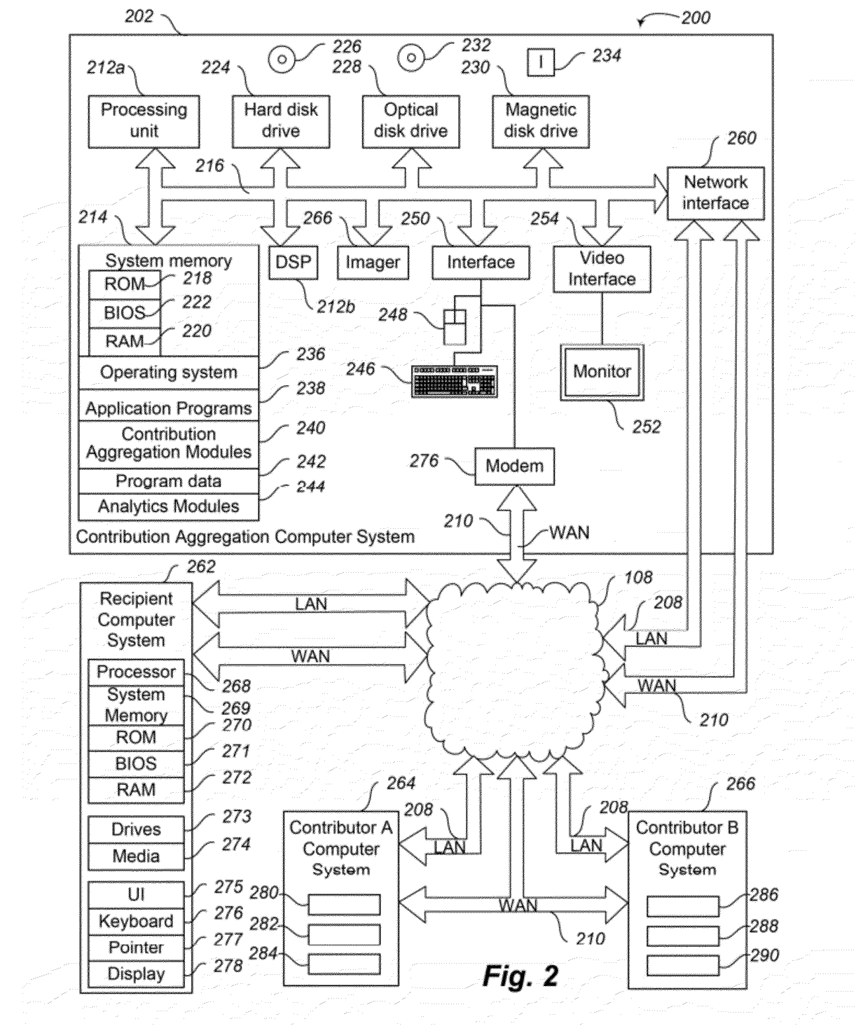

FIG. 2 shows an electronic commerce environment 200 comprising a contribution aggregation computer system 202, a recipient computer system 262, example Contributor A computer system 264 and example Contributor B computer system 266, communicatively coupled by one or more communications channels, for example one or more local area networks (LANs) 208 or wide area networks (WANs) 210 that may be part of or connect to network 108. For example, the server computing systems 102 of FIG. 1 may include the contribution aggregation computer system 202. Likewise, the number of client computing systems 106a-106n (collectively 106), telecommunications devices 111, and/or PDA devices 112 of FIG. 1 may include the recipient computer system 262, example contributor A computer system 264 and example contributor B computer system 266. Communication between the computer systems shown in FIG. 2 may also be by transferring data on a computer readable medium, such as a disk, flash drive, other memory device, etc., that is readable by such computer systems.

The recipient computer system 262 may include those computer systems of one or more various recipient entities, including, but not limited to, those of: a charitable organization, political organization, non-profit organization, governmental organization, non-governmental organization (NGO), foundation, business, political campaign, political cause, individual, etc. The example contributor A computer system 264 and example contributor B computer system 266 may include any user computer system having a Web browser on which Web sites, Web pages and/or Web applications are displayed. Such Web sites, Web pages and/or Web applications may include those hosted and/or served by contribution aggregation computer system 262, or those hosted and/or served by a Web server computer system accessible by the contribution aggregation computer system 262, contributor A computer system 264, and example contributor B computer system 266. For example, such a web server computer system may be one or more of the server computing systems 102 of FIG. 1.

Contribution aggregation computer system 202 may include those computer systems that electronically generate, execute and/or track contribution transactions or indications of contributions, stored in one or more databases or other computer-readable storage media. The contribution aggregation computer system 202 may also provide a user interface to accept, aggregate, store and/or execute contributions from example contributor A computer system 264 and example contributor B computer system 266. For example, the user interface may be displayed as, within, or on Web pages served by the contribution aggregation computer system 202, or as interfaces of other applications, including those various Web pages and Web sites of publishers, organizations, companies and individuals hosted and/or served by another Web server computer system or other computer system accessible via one or more local area networks (LANs) 208 or wide area networks (WANs) 210 that may be part of network 108.

The contribution aggregation computer system 202 will at times be referred to in the singular herein, but this is not intended to limit the embodiments to a single device since, in typical embodiments, there may be more than one contribution aggregation computer system or devices involved, or there may be multiple different computing systems that each store and/or serve different items (e.g., an web server separate from a contribution aggregation server or contribution transaction server, etc.) Unless described otherwise, the construction and operation of the various blocks shown in FIG. 2 are of conventional design. As a result, such blocks need not be described in further detail herein, as they will be understood by those skilled in the relevant art.

The contribution aggregation computer system 202 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), etc. The system bus 216 can employ any known bus structures or architectures, including a memory bus with memory controller, a peripheral bus, and a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the contribution aggregation computer system 202, such as during start-up.

The contribution aggregation computer system 202 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a digital video disc (“DVD”), while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable storage media 226, 232, 234, may provide nonvolatile and non-transitory storage of computer readable instructions, data structures, program engines and other data for the contribution aggregation computer system 202. Although the depicted contribution aggregation computer system 202 is illustrated employing a hard disk 224, optical disk 228 and magnetic disk 230, those skilled in the relevant art will appreciate that other types of computer-readable storage media that can store data accessible by a computer may be employed, such as magnetic cassettes, flash memory, compact discs (“CD”), Bernoulli cartridges, RAMs, ROMs, smart cards, solid state drives, etc.

The contribution aggregation computer system 202 may include a network interface 260 operably coupled to the system bus 216. The network interface 260 may, for example, include one or more modems 252 and/or one or more Ethernet cards or other types of communications cards or components 254 for enabling communications via one or more local area networks (LANs) 208 or wide area networks (WANs) 210.

Program engines can be stored in the system memory 214, such as an operating system 236, one or more application programs 238, contribution aggregation modules 240, program data 242 and analytics modules 244. Application programs 238 and contribution aggregation modules 240 may include instructions that cause the processor(s) 212 to accept, aggregate, store and/or execute contributions from contributor A computer system 264, contributor B computer system 266, and/or other contributor computer systems to one or more recipient computer systems, including, for example, recipient computer system 262. Application programs 238 and contribution aggregation modules 240 may include computer executable instructions and functionality to deliver such services over the LAN 208 or WAN 210 using one or more, or a combination of one or more network protocols including, but not limited to, hypertext transfer protocol (HTTP), TCP/IP protocol, UDP protocols, and IEEE 802.11 protocol, as well as other telecommunications or computer networking protocols.

Application programs 238 and contribution aggregation modules 240 may also include instructions for handling security such as password or other access protection and communications encryption and also enable access and exchange data with sources such as corporate intranets, extranets, or other networks as described below, as well as other server applications on server computing systems such as those discussed further below. The system memory 214 may also include analytics modules or programs, for example analytics module 244, configured to analyze and perform statistical analyses on contributions and/or contribution transactions. For example, these analyses may be based on a particular recipient, reasons for contributions to a particular recipient, or based on particular contributors and reasons for contributions from a particular contributor, etc.

While shown in FIG. 2 as being stored in the system memory 214, the operating system 236, application programs 238, contribution aggregation modules 240, program data 242 and analytics modules 244 can be stored on the hard disk 226 of the hard disk drive 224, the optical disk 232 of the optical disk drive 228 and/or the magnetic disk 234 of the magnetic disk drive 230.

An operator can enter commands and information into the contribution aggregation computer system 202 through input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The contribution aggregation computer system 202 can include other output devices, such as speakers, printers, etc.

The contribution aggregation computer system 202 can operate in a networked environment using logical connections to one or more remote computers and/or devices as described above with reference to FIG. 1. For example, the contribution aggregation computer system 202 can operate in a networked environment using logical connections to one or more recipient computer systems 262, and one or more to one or more recipient computer systems, for example, contributor A computer system 264 and/or contributor B computer system 266. Communications may be via a wired and/or wireless network architecture, for instance, wired and wireless enterprise-wide computer networks, intranets, extranets, and the Internet. Other embodiments may include other types of communications networks including telecommunications networks, cellular networks, paging networks, and other mobile networks.

The recipient computer system 262 may take the form of a conventional mainframe computer, mini-computer, workstation computer, personal computer (desktop or laptop). The recipient computer system 262 may include a processing unit 268, a system memory 269 and a system bus (not shown) that couples various system components including the system memory 269 to the processing unit 268. The recipient computer system 262 will at times be referred to in the singular herein, but this is not intended to limit the embodiments to a single recipient computer system 262 since in typical embodiments, there may be more than one recipient computer system 262 or other device involved. Non-limiting examples of commercially available computer systems include, but are not limited to, an 80x86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 268 may be any logic processing unit, such as one or more central processing units (CPUs), digital signal processors (DSPs), application-specific integrated circuits (ASICs), field programmable gate arrays (FPGAs), etc. Unless described otherwise, the construction and operation of the various blocks of the Recipient computer system 262 shown in FIG. 2 are of conventional design. As a result, such blocks need not be described in further detail herein, as they will be understood by those skilled in the relevant art.

The system bus can employ any known bus structures or architectures, including a memory bus with memory controller, a peripheral bus, and a local bus. The system memory 269 includes read-only memory (“ROM”) 270 and random access memory (“RAM”) 272. A basic input/output system (“BIOS”) 271, which can form part of the ROM 270, contains basic routines that help transfer information between elements within the peripheral computing system 114, such as during start-up.

The recipient computer system 262 may also include one or more media drives 273 (e.g., a hard disk drive, magnetic disk drive, and/or optical disk drive) for reading from and writing to computer-readable storage media 274 (e.g., hard disk, optical disks, and/or magnetic disks). The computer-readable storage media 274 may, for example, take the form of removable media. For example, hard disks may take the form of Winchester drives, optical disks can take the form of DVDs, while magnetic disks can take the form of magnetic floppy disks or diskettes. The media drive(s) 273 communicate with the processing unit 268 via one or more system buses. The media drives 273 may include interfaces or controllers (not shown) coupled between such drives and the system bus, as is known by those skilled in the relevant art. The media drives 273, and their associated computer-readable storage media 274, provide nonvolatile storage of computer readable instructions, data structures, program engines and other data for the recipient computer system 262. Although described as employing computer-readable storage media 274 such as hard disks, optical disks and magnetic disks, those skilled in the relevant art will appreciate that recipient computer system 262 may employ other types of computer-readable storage media that can store data accessible by a computer, such as magnetic cassettes, flash memory cards, compact discs (“CD”), Bernoulli cartridges, RAMs, ROMs, smart cards, solid state drives, etc.

Program engines, such as an operating system, one or more application programs, other programs or engines and program data, can be stored in the system memory 269. Program engines may include instructions for handling security such as password or other access protection and communications encryption. The system memory 269 may also include communications and server programs, for example a Web server that permits the recipient computer system 262 to accept electronic contributions, such as those sent over the Internet and/or Web applications and also access and exchange data with sources such as corporate intranets, extranets, or other networks as described below, as well as other server applications on server computing systems such as those discussed further below.

While described as being stored in the system memory 269, the operating system, application programs, other programs/engines, program data and/or browser can be stored on the computer-readable storage media 274 of the media drive(s) 273. An operator can enter commands and information into the Recipient computer system 262 via a user interface 275 through input devices such as a touch screen or keyboard 276 and/or a pointing device 277 such as a mouse. Other input devices can include a microphone, joystick, game pad, tablet, scanner, etc. These and other input devices are connected to the processing unit 269 through an interface such as a serial port interface that couples to the system bus, although other interfaces such as a parallel port, a game port or a wireless interface or a universal serial bus (“USB”) can be used. A display or monitor 278 may be coupled to the system bus via a video interface, such as a video adapter. The Recipient computer system 262 can include other output devices, such as speakers, printers, etc.

The recipient computer system 262 includes instructions stored in non-transitory computer-readable storage media that cause the processor(s) of the recipient computer system 262 to accept electronic contributions, such as those sent over the Internet and/or Web applications, through the contribution aggregation computer system 202 from various contributor computer systems over the LAN 208 or WAN 210, including, for example, those from contributor A computer system 264 and contributor B computer system 266. The recipient computer system 262 includes instructions stored in non-transitory computer-readable storage media that cause the processor(s) of the recipient computer system 262 to receive additional information and analyses from the contribution aggregation computer system 202 regarding contributions from contributor A computer system 264 and contributor B computer system 266.

The contributor A computer system 264 may have identical or similar components to the previously described computer systems, for example a processing subsystem 280 including one or more non-transitory processor and computer-readable memories, a media subsystem including one or more drives and computer-readable storage media, and one or more user interface subsystems 282 including one or more keyboards, keypads, displays, pointing devices, graphical interfaces and/or printers.

The contributor A computer system 264 includes program instructions stored in non-transitory computer-readable storage media such as those program instructions of a Web browser 284 configured to access the services of the contribution aggregation computer system 202. The browser 284 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Mozilla, Google and Microsoft.

The contributor B computer system 266 may have identical or similar components to the previously described computer systems, for example a processing subsystem 286 including one or more non-transitory processor and computer-readable memories, a media subsystem 288 including one or more drives and computer-readable storage media, and one or more user interface subsystems 290 including one or more keyboards, keypads, displays, pointing devices, graphical interfaces and/or printers.

For example, the contributor B computer system 266 may include program instructions stored in non-transitory computer-readable storage media such those program instructions of a Web browser 290 configured to access the services of the contribution aggregation computer system 202 similar to that of Web browser 284 of contributor A computer system 264 described above. Although there are only two example contributor computer systems depicted in FIG. 2, there may be fewer or more such contributor computer systems operably connected to LAN 208 and/or WAN 210 in various other embodiments.

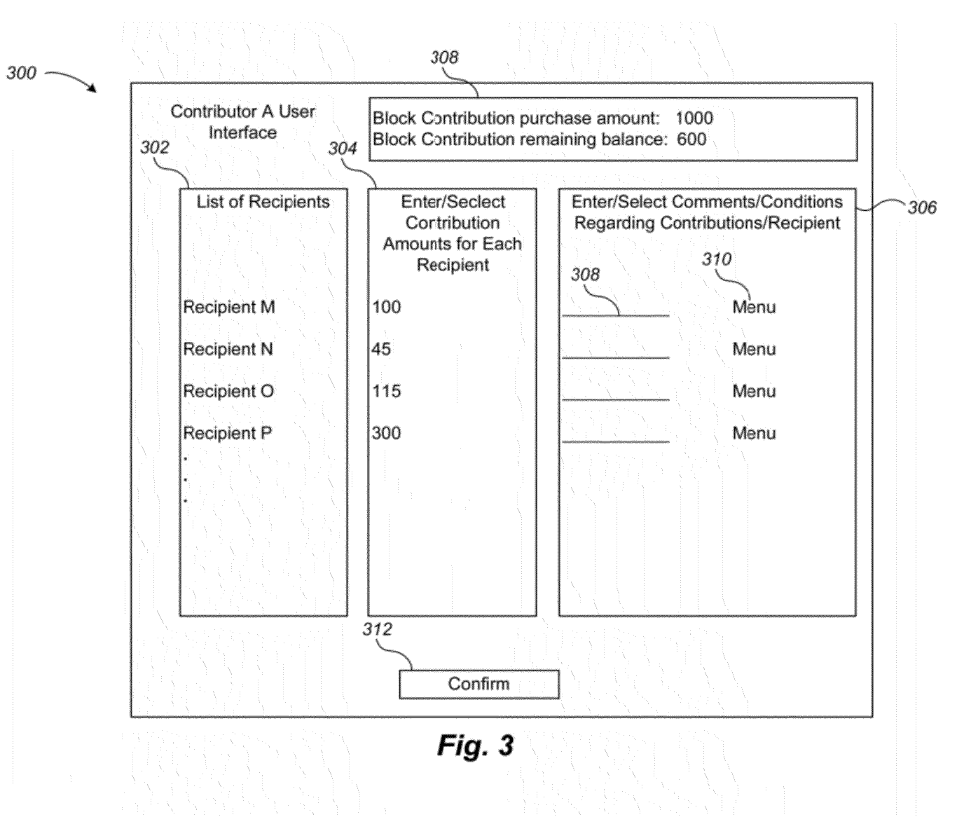

FIG. 3 is a diagram of an example user interface 300 that may be displayed on the contributor A computer system 264, according to one illustrated embodiment. A user may purchase or otherwise acquire a block of one or more contribution units from or through the contribution aggregation system 202. The contribution aggregation system 202 enables user to contribute desired amounts to selected recipients using the block of one or more contribution units and deducts units from the block of one or more contribution units as they are contributed to selected recipients. This may be performed, for example, by the user logging on to a Web site or other system interface provided by the contribution aggregation computer system 202 and purchasing the units electronically. The units may be any denomination of something of value including monetary currency, credits, work hours, a number of physical items, etc. User interface item 308 shows an example initial amount of units (1000) purchased by the user and a current remaining balance (600).

User interface item 302 of user interface 300 is configured to display a selectable list of recipients from which the user (e.g., contributor A) may select in order to indicate individual recipients to which the user intends to make contributions. User interface item 304 displays selectable entry fields or selectable contribution amounts for the user to indicate the amount of a contribution to be made to each individual selected recipient form the user. For example, contributor A has selected recipient M to receive 100 units from the block contribution amount purchased by contributor A. Also, contributor A has selected recipient N to receive 45 units from the block contribution amount purchased by contributor A, selected recipient O to receive 115 units from the block contribution amount purchased by contributor A, and selected recipient P to receive 300 units from the block contribution amount purchased by contributor A. As shown in user interface item 308, this leaves 600 units in the block contribution remaining balance for contributor A.

User interface item 306 displays selectable entry fields or selectable comments, reasons and/or conditions for the user to indicate comments, reasons and/or conditions for each individual contribution and associated recipient. For example, contributor A may type in comments in entry field 308 regarding the contribution and/or recipient such as the reason the contribution was made, comments about the recipient in general and/or specify conditions the recipient must meet, or acts the recipient must perform, in order to receive or keep the contribution. Also or alternatively, the user may select items from a menu 310 indicating pre-set comments regarding the contribution and/or recipient such as the reason the contribution was made, comments about the recipient in general and/or specific conditions the recipient must meet, or acts the recipient must perform, in order to receive or keep the contribution. Selecting pre-set or pre-defined items facilitate the aggregation computer system 202 being able to automatically perform statistical analyses on contributions and/or specific recipients. These analyses may be based on a particular recipient, reasons for contributions to a particular recipient, or based on particular contributors and reasons for contributions from a particular contributor, etc. For example, the aggregation computer system 202 may calculate the most common reason for contributions made to a particular recipient, may calculate a ranking from the most common to the least common reason for contributions made to a particular recipient, a group of recipients, or all the recipients, etc. This information may also be provided by the aggregation computer system 202 to the various recipients or otherwise electronically published or communicated.

User interface item 312 is selectable by the user to communicate their confirmation of their selections and contributions and continue to a next step in the process, such as an electronic receipt page, tax deduction information page, selected recipient information page, additional comment page, a page for selection of the recipients to receive comments, etc. Other user interfaces, pages and selectable items may be provided to facilitate purchase of one or more contribution units, selections of recipients and contribution amounts, display of contribution analyses and amounts, reasons provided for contributions, execution of contribution transactions, contributor and recipient account management, and acceptance of contributions by recipients.

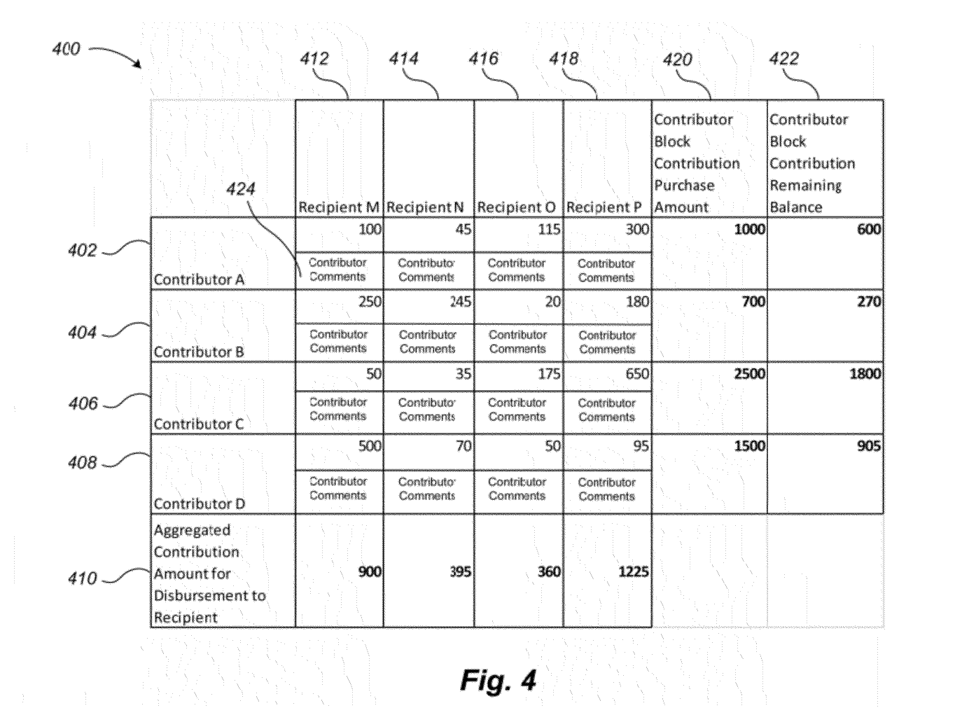

FIG. 4 is a diagram of an example database 400 table of the aggregation computer system, according to one illustrated embodiment. Information collected by the aggregation computer system 202 is stored and aggregated, for example, such that each contribution to an individual recipient is totaled for analyses purposes and disbursement to the recipient in a single transaction. Shown is a column 412 for the example recipient M, a column 414 for example recipient N, a column 416 for example recipient O, and a column 418 for example recipient N. Also shown is a row 402 for example contributor A, a row 404 for example contributor B, a row 406 for example contributor C, and a row 408 for example contributor D. Each contribution amount for each individual recipient is stored and the total contribution amounts are calculated for each recipient by the aggregation computer system 202. For example, recipient M received contributions of 100 units from contributor A, 250 units from contributor B, 50 units from contributor C, and 500 units from contributor D. This results in a total of 900 units from all the recipients, which is shown in the “Aggregated Contribution Amount for Disbursement to Recipient” column 410. Similarly calculated totals are stored for the other recipients (i.e., recipient N, recipient O and recipient P). The specific number of example contributors and recipients shown in FIG. 4 is for illustrative purposes and there may be fewer or more recipients and/or contributors in various other embodiments.

The timing determined for aggregation of contributions and subsequent disbursement of the total contribution in a single transaction may be based on determined amounts of times (e.g., daily, weekly, monthly, quarterly, yearly, etc.) and/or be based on a minimum or maximum contribution total amount for the particular recipient. The timing may be selectable by the recipient, contributor and/or the contribution aggregation system 202.

Also, the total amounts of contributions made by each contributor may be stored for further analysis and to facilitate accounting of the contribution block purchases made by the individual contributors. Shown in column 420 is the initial block purchase amount for each individual contributor and shown in column 422 is the block contribution remaining balance for each individual contributor, based on the total contributions made to one or more recipients from each individual contributor. For example, contributor A initially purchased a block amount of 1000 units and then subsequently contributed 400 of those units to various recipients (i.e., recipient M, recipient N, recipient O and recipient P). Thus, the remaining balance of the block contribution for contributor A is 600 units. For example, for the convenience of contributor A, this is also shown on the contributor A user interface 300 of FIG. 3 on user interface item 308. Contributor A may at any time purchase additional blocks of one or more contribution units via the contribution aggregation system 202, which would result in an increase in the contributor block contribution purchase amount shown in column 420 and the block contribution remaining balance shown in column 422.

Also, the comments input and/or selected in user interface item 306 regarding the contribution and/or recipient, such as the reason the contribution was made, comments about the recipient in general and/or specific conditions the recipient must meet or acts the recipient, another related or unrelated party or entity, etc., must perform, or event that must be performed or occur, in order to receive or keep the contribution, are associated with the specific contribution and stored for further analysis and/or to facilitate execution of a contribution transaction. For example, shown are comments 424 in column 412. Comments 424 are associated with the contribution of 100 units from contributor A to recipient M. The comments 424, for example, may indicate that recipient M must provide confirmation that the contribution of 100 units will be used for a particular non-profit program of recipient M before a contribution transaction including the 100 units from contributor A will be executed or enabled by the contribution aggregation system 202 (i.e., before contributor A will release the contribution funds or otherwise allow the contribution). Such confirmation, for example, may be an electronic communication provided by recipient M to the contribution aggregation system 202, and then communicated to contributor A via the contribution aggregation system 202. Thus, particular contributions may have a different status associated with the contribution regarding availability of the contribution for inclusion in an aggregated transaction, or being otherwise available for disbursement.

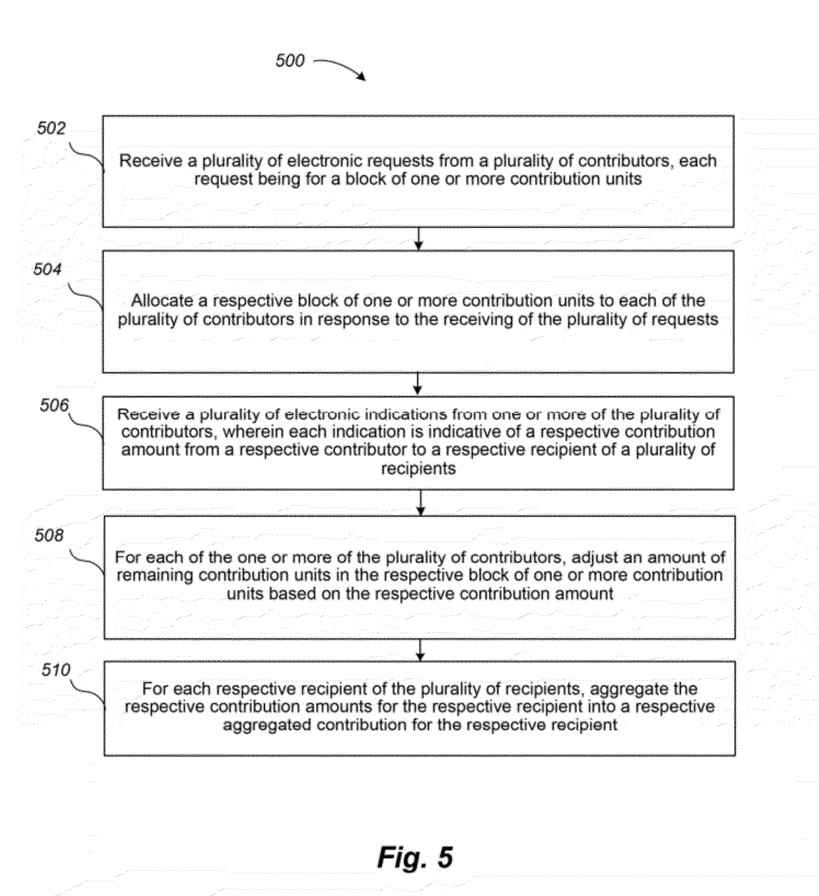

FIG. 5 shows a method 500 for electronically aggregating respective contribution amounts, according to one illustrated embodiment, according to one illustrated embodiment.

The method 500 starts at 502, in which the contribution aggregation computer system 202 shown in FIG. 2 receives a plurality of electronic requests from a plurality of contributors, each request being for a block of one or more contribution units.

At 504, the contribution aggregation computer system 202 allocates a respective block of one or more contribution units to each of the plurality of contributors in response to the receiving of the plurality of requests.

At 506, the contribution aggregation computer system 202 receives a plurality of electronic indications from one or more of the plurality of contributors, wherein each indication is indicative of a respective contribution amount from a respective contributor to a respective recipient of a plurality of recipients.

At 508, the contribution aggregation computer system 202, for each of the one or more of the plurality of contributors, adjusts an amount of remaining contribution units in the respective block of one or more contribution units based on the respective contribution amount.

At 510, the contribution aggregation computer system 202, for each respective recipient of the plurality of recipients, aggregates the respective contribution amounts for the respective recipient into a respective aggregated contribution for the respective recipient. For example, the single transaction may be an electronic funds transfer, an electronic indication made to a financial institution or other clearing house, an electronic initiation of a check being sent, and automated clearing house (ACH) transaction, a money wire, or an initiation of a money wire, a manually written or automatically printed check, etc.

Also, the contribution aggregation computer system 202 may receive data from one or more contributors regarding the respective contribution amount. For example, this data may be regarding reasons or motivations that a contributor made the respective contribution amount. The contribution aggregation computer system 202 then may electronically publish such information, print or otherwise distribute such information, provide automated analyses of this information to the recipient and/or contributor, and/or electronically provide such information to governmental organizations, non-governmental organizations (NGOs), or other related or unrelated party or entity. This information may be electronically provided along with or otherwise accompany the contribution transaction to the specific recipient as it relates to the specific recipient.

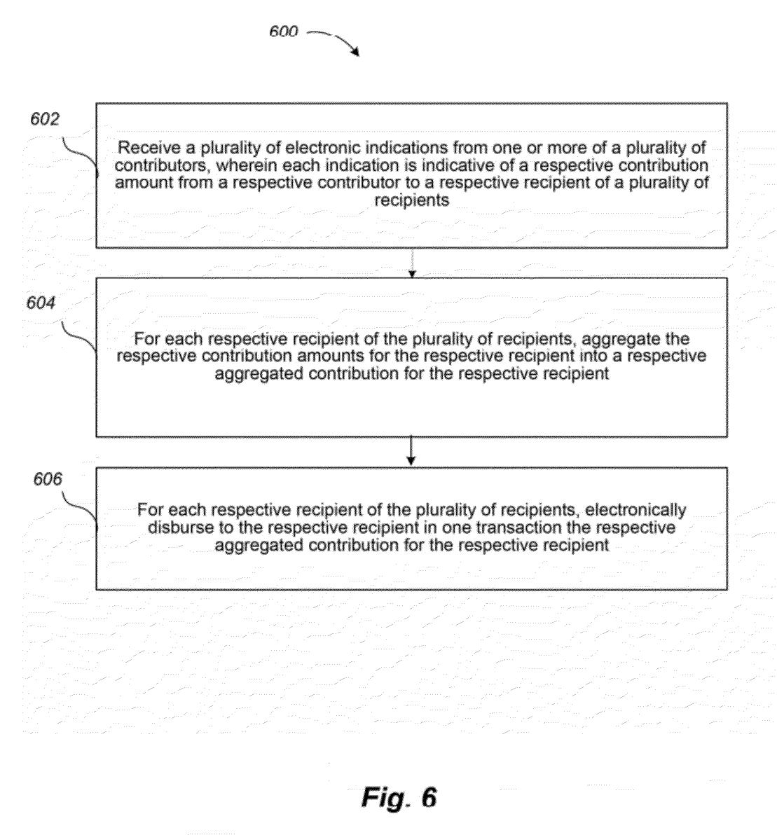

FIG. 6 shows a method 600 for electronically disbursing aggregated contributions, according to one illustrated embodiment.

The method 600 starts at 602, in which the contribution aggregation computer system 202 shown in FIG. 2 receives a plurality of electronic indications from one or more of a plurality of contributors, wherein each indication is indicative of a respective contribution amount from a respective contributor to a respective recipient of a plurality of recipients.

At 604, the contribution aggregation computer system 202, for each respective recipient of the plurality of recipients, aggregates the respective contribution amounts for the respective recipient into a respective aggregated contribution for the respective recipient.

At 606, the contribution aggregation computer system 202, for each respective recipient of the plurality of recipients, electronically disburses to the respective recipient in one transaction the respective aggregated contribution for the respective recipient.

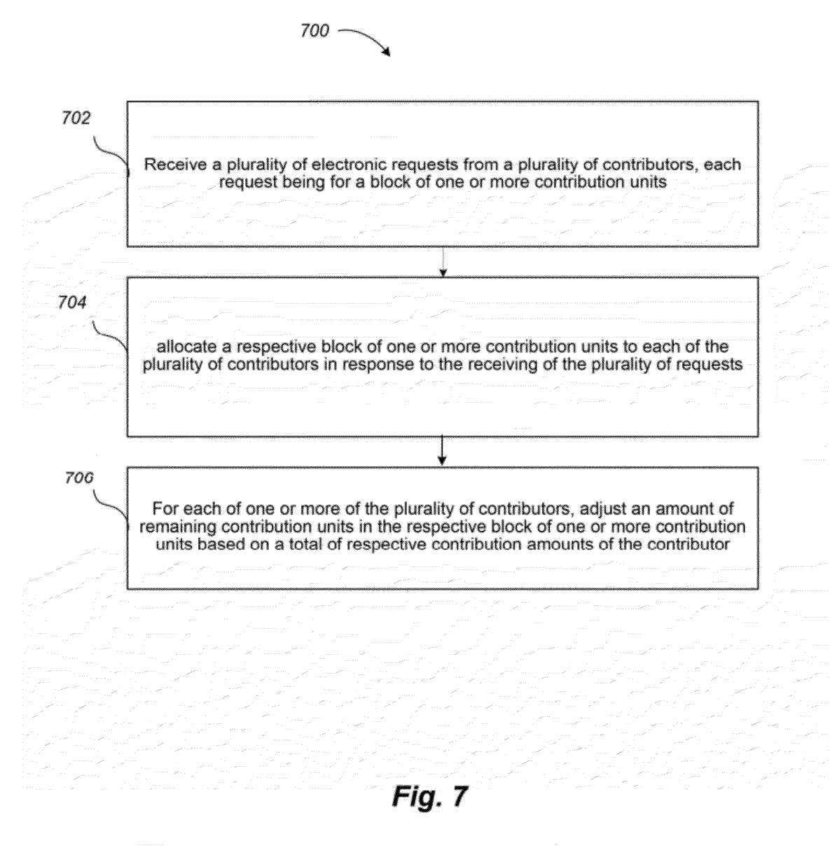

FIG. 7 shows a method 700 for electronically disbursing aggregated contributions, according to one illustrated embodiment.

The method 700 starts at 702, in which the contribution aggregation computer system 202 shown in FIG. 2 receives a plurality of electronic requests from a plurality of contributors, each request being for a block of one or more contribution units.

At 704, the contribution aggregation computer system 202 allocates a respective block of one or more contribution units to each of the plurality of contributors in response to the receiving of the plurality of requests.

At 706, the contribution aggregation computer system 202, for each of one or more of the plurality of contributors, adjusts an amount of remaining contribution units in the respective block of one or more contribution units based on a total of respective contribution amounts of the contributor.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary contribution aggregation computer system described above. In some embodiments, one or more of the recipient computer systems and the contribution aggregation computer system may be one system or controlled by one entity. Also, in some embodiments, the features and functionality described above may be implemented on one stand-alone system.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as portable disks and memory, hard disk drives, DVDs, CD ROMs, digital tape, and computer memory; and other non-transitory computer-readable storage media.

The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating an electronic contribution aggregation and allocation system including at least one processor and at least one non-transitory computer readable medium coupled to the at least one processor, the method comprising:
receiving a plurality of electronic requests from a plurality of contributors by the at least one processor, each request being for a block of one or more contribution units;
allocating a respective block of one or more contribution units to each of the plurality of contributors, by the at least one processor, in response to the receiving of the plurality of requests;
receiving a plurality of electronic indications from one or more of the plurality of contributors by the at least one processor, wherein each indication is indicative of a respective contribution amount from a respective contributor to a respective recipient of a plurality of recipients;
for each of the one or more of the plurality of contributors, adjusting an amount of remaining contribution units in the respective block of one or more contribution units based on the respective contribution amount, by the at least one processor; and
for each respective recipient of the plurality of recipients, aggregating the respective contribution amounts for the respective recipient into a respective aggregated contribution for the respective recipient, by the at least one processor.

2. The computer-implemented method of claim 1, further comprising:
for each respective recipient of the plurality of recipients, electronically disbursing in one transaction to the respective recipient the respective aggregated contribution for the respective recipient by the at least one processor.

3. The computer-implemented method of claim 1, further comprising:
for at least one of the one or more of the plurality of contributors:
receiving data regarding the respective contribution amount, by the at least one processor;
associating the received data regarding the respective contribution amount with the respective recipient, by the at least one processor;
storing the received data regarding the respective contribution amount; and
storing the association of the received data regarding the respective contribution amount, by the at least one processor.

4. The computer-implemented method of claim 3 wherein the received data regarding the respective contribution amount is data regarding reasons or motivations that the at least one of the one or more of the plurality of contributors made the respective contribution amount.

5. The computer-implemented method of claim 4 further comprising electronically publishing the data regarding the respective contribution amount by the at least one processor.

6. The computer-implemented method of claim 4 further comprising:
electronically publishing the data regarding the respective contribution amount, by the at least one processor; and
electronically publishing the respective contribution amount in relation to the data regarding the respective contribution, by the at least one processor.

7. The computer-implemented method of claim 4 wherein the at least one of the one or more of the plurality of contributors includes multiple contributors and further comprising:
aggregating, by the at least one processor, the received data regarding the respective contribution amount from the each of the multiple contributors based on the respective recipient; and
electronically communicating, by the at least one processor, the aggregated received data for the respective recipient to the respective recipient along with the electronic disbursement to the respective recipient.

8. The computer-implemented method of claim 3 wherein the received data regarding the respective contribution amount is data regarding a condition for disbursing the respective contribution amount, the condition being a status or action of the respective recipient.

9. The computer-implemented method of claim 8 further comprising:
receiving, by the at least one processor, an electronic indication indicating whether the condition has been met; and
electronically disbursing, by the at least one processor, the respective contribution amount if the received electronic indication indicates the condition has been met; and
preventing, by the at least one processor, electronic disbursing of the respective contribution amount if the received electronic indication indicates the condition has not been met.

10. The computer-implemented method of claim 1 wherein the receiving a plurality of electronic indications is performed before the receiving the plurality of electronic requests and the allocating the respective block of one or more contribution units.

11. A system, comprising:
at least one processor;
at least one processor-readable memory that stores instructions executable by the at least one processor to cause the at least one processor to:
receive a plurality of electronic indications from one or more of a plurality of contributors, wherein each indication is indicative of a respective contribution amount from a respective contributor to a respective recipient of a plurality of recipients; and
for each respective recipient of the plurality of recipients, aggregate the respective contribution amounts for the respective recipient into a respective aggregated contribution for the respective recipient; and
for each respective recipient of the plurality of recipients, electronically disburse to the respective recipient in one transaction the respective aggregated contribution for the respective recipient.

12. The system of claim 11, wherein the instructions executable by the at least one processor further cause the at least one processor to:
for each of the one or more of the plurality of contributors:
receive data regarding the respective contribution amount;
associate the received data regarding the respective contribution amount with the respective contribution amount and the respective recipient;
store the received data regarding the respective contribution amount; and
store the association of the received data regarding the respective contribution amount.

13. The system of claim 12, wherein the data regarding the respective contribution amount includes data regarding a reason for making the respective contribution and the instructions executable by the at least one processor further cause the at least one processor to:
for each respective recipient of the plurality of recipients, generate statistical data regarding one or more reasons why contributions were made to the respective recipient based on the stored association of the received data regarding the respective contribution amount from each of the one or more of the plurality of contributors.

14. The system of claim 13, wherein the instructions executable by the at least one processor further cause the at least one processor to:
for each respective recipient of the plurality of recipients, electronically communicate to the respective recipient the generated statistical data regarding the one or more reasons why contributions were made to the respective recipient.

15. The system of claim 14, wherein the instructions executable by the at least one processor further cause the at least one processor to:
electronically publish the generated statistical data regarding the one or more reasons why contributions were made to the respective recipient.

16. The system of claim 11, wherein the instructions executable by the at least one processor further cause the at least one processor to:
generate a user interface to enable entering the respective contribution amount from the respective contributor to the respective recipient, the user interface including:
a list of the a plurality of recipients;
an area of the user interface associated with the list of the plurality of recipients configured to enable an indication to be entered by the respective contributor of an amount of contribution to be made to one or more of the plurality of recipients;
an area of the user interface to enable the user to input information regarding one or more of: the respective contribution and the respective recipient.

17. The system of claim 16 wherein the information includes one or more of: a reason for making the respective contribution and comments regarding the respective recipient.

18. The system of claim 11, wherein the instructions executable by the at least one processor further cause the at least one processor to:
receive a plurality of electronic requests from the plurality of contributors, each request being for a block of one or more contribution units; and
allocate a respective block of one or more contribution units to each of the plurality of contributors in response to the receiving of the plurality of requests.

19. A non-transitory computer-readable medium that stores instructions that when executed by at least one computer system cause the at least one computer system to perform:
receiving a plurality of electronic requests from a plurality of contributors, each request being for a block of one or more contribution units;
allocating a respective block of one or more contribution units to each of the plurality of contributors in response to the receiving of the plurality of requests; and
for each of one or more of the plurality of contributors, adjusting an amount of remaining contribution units in the respective block of one or more contribution units based on a total of respective contribution amounts of the contributor.

20. The non-transitory computer-readable medium of claim 19 wherein the instructions further cause the at least one computer system to perform:
for at least one of the one or more of the plurality of contributors:
receiving data regarding a respective contribution amount of the at least one contributor;
associating the received data regarding the respective contribution amount with a respective recipient;
storing the received data regarding the respective contribution amount; and
storing the association of the received data regarding the respective contribution amount.

21. The non-transitory computer-readable medium of claim 21 wherein the received data regarding the respective contribution amount is data regarding reasons or motivations that the at least one contributor made the respective contribution amount.
